(19) United States
(12) Patent Application Publication
(10) Pub. No.: US 2004/0084240 A1
(43) Pub. Date: May 6, 2004

(54) Exhaust system sound-reducing componment

(76) Inventor: Sydney Gearing, Grand Blanc, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/690,360

(22) Filed: Oct. 21, 2003

Related U.S. Application Data
(60) Provisional application No. 60/420,279, filed on Oct. 22, 2002.

(51) Int. Cl. B60K 13/04

(52) U.S. Cl. 180/309

(57) ABSTRACT

An exhaust system sound-reducing component for use with a silencer on an off-road vehicle. The component includes an adapter, an exhaust extension and a U-joint that connects the adapter with the extension. The adapter includes an exhaust port that communicates with the atmosphere and a discharge opening that communicates with the exhaust extension. One portion of the exhaust and sound from the silencer is transmitted the exhaust port while another portion is transmitted through the discharge opening in the adaptor, through the exhaust passage, the U-joint and the exhaust extension and out to the atmosphere. As such, any sound traveling with the exhaust exiting the exhaust port of the chamber will be out of phase with any sound exiting the exhaust opening. This out of phase action of the sound results in reduced noise levels.

### RELATED APPLICATION

This application claims priority of U.S. Provisional Patent Application Serial No. 60/420,279 filed Oct. 22, 2002, which is incorporated herein by reference.

### BACKGROUND OF THE INVENTION

1. Field of the Invention

The present invention is directed to a sound-reducing component for use with a vehicle silencer. More particularly, the present invention concerns a device for muffling exhaust noise from a silencer (including spark arrested and non-spark arrested silencers) for an off-road vehicle.

2. Reference to Related Art

Off-road vehicles such as motocross type motorcycles/motorbikes, three or four wheel all-terrain vehicles (“ATV”) and dune buggies provide users with hours of high-adventure enjoyment. Indeed, such vehicles allow the user to easily travel and explore country roads, open fields, rugged mountains, deep forests and scenic coastlines. However, more and more of these vehicles are being subjected to government regulations governing the ownership and operation of the vehicle. One such regulation is the recently adopted noise level standard enacted by the U.S. Forest Service that limits the operation noise for off-road vehicles to 96 decibels at one-half meter. See IC 67-7125. This noise level standard is in addition to Forest Service rules governing the use of spark arresters on off-road vehicles. Specially, during fire season all off-road vehicles must have a Forest Service approved spark arrestor, shovel and bucket.

Many commercially available spark arresters and combined spark-arrested silencers comply with Forest Service spark regulations. However, these same devices do not meet the new Forest Service standards regarding sound level. Indeed, while many commercially available spark-arrested silencers are identified as “Forest Service Approved”, they are generally only approved insofar as they comply with Forest Service spark safety standards. Therefore, it would be advantageous to provide an adapter or similar device that can be used with all manner of commercially available spark arresters and spark-arrested silencers to further reduce exhaust noise from those devices to at or below the maximum noise level regulated by the U.S. Forest Service.

### SUMMARY OF THE INVENTION

The present invention is directed to an exhaust system sound-reducing component for use with an off-road vehicle. The component includes an adapter, an exhaust extension and a U-joint that connects the adapter with the extension. The adapter, extension and U-joint may be constructed as separate subassemblies or, alternatively, may be constructed as an integral unit.

The adapter of the component includes an exhaust discharge chamber and an exhaust passage. The exhaust discharge chamber has an open end that is positioned over an exhaust end of a silencer of an off-road vehicle. An exhaust port is positioned in the exhaust discharge chamber opposite the exhaust end of the silencer and provides an opening from the chamber to the atmosphere. A discharge opening is defined in the chamber that communicates exhaust and sound from the chamber into the exhaust passage.

The U-joint is secured at one end by connectors to an end of the exhaust passage opposite the discharge opening and at the other end to the exhaust extension.

The exhaust extension has an end that is secure to the other end of the U-joint and an exhaust opening. Exhaust and sound from the silencer is transmitted through the discharge opening in the adaptor, through the exhaust passage, the U-joint and the exhaust extension and out to the atmosphere through the exhaust opening. As such, any sound traveling with the exhaust exiting the exhaust port of the chamber will be out of phase with any sound exiting the exhaust opening. This out of phase action of the sound results in reduced decibel levels.

### BRIEF DESCRIPTION OF THE DRAWINGS

A better understanding of the invention will be had upon reference to the attached drawings wherein like reference numerals refer to like parts throughout and wherein:

FIG. 1 is a side environmental view of an exhaust system sound-reducing component constructed in accordance with a preferred embodiment of the present invention that is mounted on a four wheel ATV;

FIG. 2 is a perspective view of an exhaust system sound-reducing component;

FIG. 3 is an overhead, partial cut-away view of the adaptor and exhaust extension of an exhaust system sound-reducing component;

FIG. 4 is a planar rear view of the adaptor and exhaust extension of an exhaust system sound-reducing component;

FIG. 5 is a cut-away view of the adaptor and exhaust extension of an exhaust system sound-reducing component taken along line 5-5 of FIG. 4;

FIG. 6 is a planar side view of a fastener for mounting the exhaust system sound-reducing component to an off-road vehicle; and

FIG. 7 is a planar side view of a connector for joining portions of the exhaust extension of the present invention.

### DETAILED DESCRIPTION OF THE INVENTION

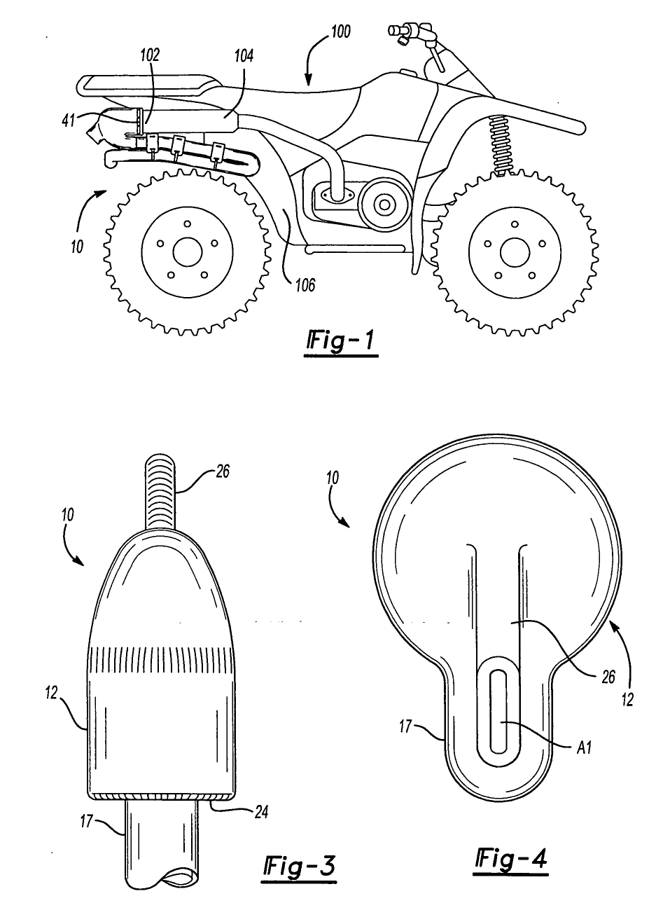

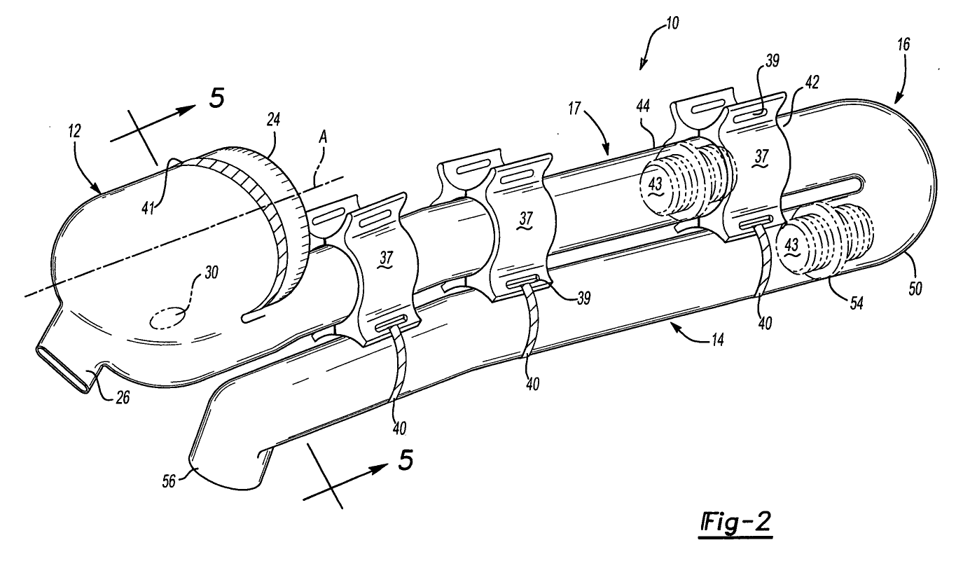

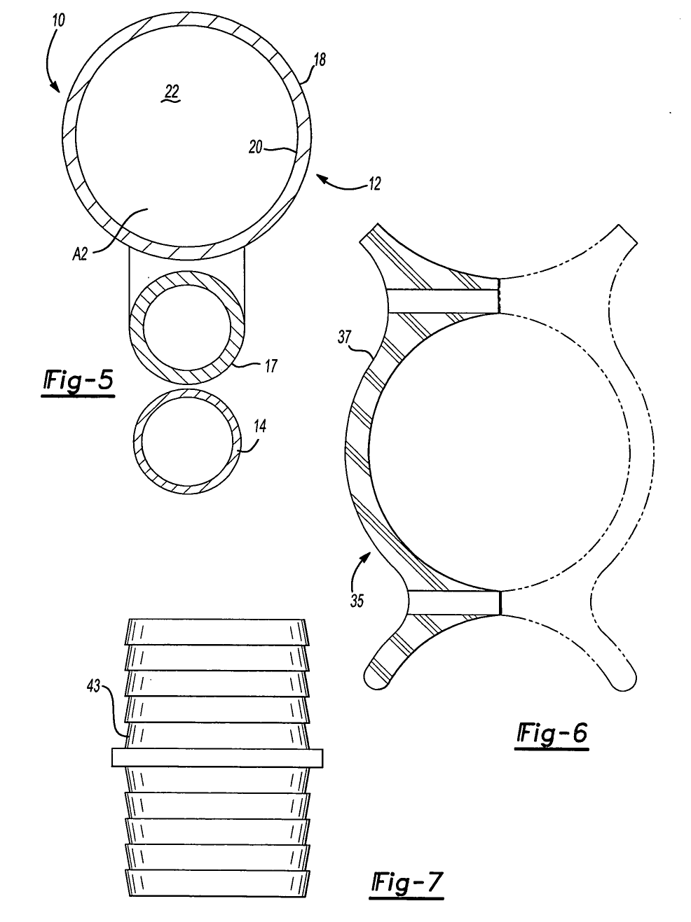

Referring now to FIGS. 1-5 and as best shown in FIGS. 1 and 2, there is shown an exhaust system sound-reducing component 10 for use with an off-road vehicle 100. The component 10 includes an adapter 12, an exhaust extension 14 and a U-joint 16 that connects the adapter 12 with the extension 14. The component 10 is constructed of a flexible sound-deadening and heat-resistant material (e.g., vehicle approved tubing). However, various other metals, composites and combinations thereof can be used in constructing the present invention. The component 10 has a generally tubular construction such that exhaust and sound is communicated from the adapter 12, through the U-joint 16 and out the extension 14. As used herein, the term “off-road vehicle” includes, but is not limited to motorcycles, three or four wheel all-terrain vehicles, watercraft (including jet-skies), snowmobiles and dune buggies. Furthermore, while the adapter 12, extension 14 and U-joint 16 are discussed as separate subassemblies, it will be appreciated that the component 10 may also be constructed as a single integral unit.

Still referring to FIGS. 1-5, the adapter 12 includes an exhaust passage 17 and has a wall 18 with an inner surface 20 that defines an exhaust discharge chamber 22. The chamber 22 includes an open end 24 that is positionable over an exhaust end 102 of a silencer 104 or the like for an off-road vehicle. Accordingly, the open end 24 of the chamber 22 may be constructed in various configurations such that the invention may be adapted to fit all manner of commercially available silencers 104. The silencer 104 may be a spark-arrested silencer or a non-spark arrested silencer.

An exhaust port 26 is positioned at an opposite end 28 of the chamber 22 and extends outwardly from the rear of the adapter 12. The port 26 allows a portion of the exhaust and sound being emitted from the silencer 104 to travel into the atmosphere. The port 26 is oriented at an angle between 0 and 90 degrees relative to the axis “A” of the chamber 22 of the adapter 12 and has an area A1 that is smaller than the area A2 of the open end 24 of chamber 22. A discharge opening 30 is defined by the inner surface 20 of the wall 18 in the chamber 22 to communicate exhaust gas and sound from the discharge chamber 22 to an exhaust passage 17.

The exhaust passage 17 of the adapter 12 extends back along (or substantially parallel to) an outer surface 106 of the off-road vehicle 100 or, alternatively, the silencer 104. As best shown in FIGS. 1, 2 and 6, fasteners 35 such as clamps 37 or other of fittings that known in the art (e.g., ties, bolts, screws, adhesives) are used to secure the exhaust passage 32 and thus the adapter 12 to the off-road vehicle 100 or silencer 104. The clamps 37 include openings 39 that permit the use of ties 40 or the like to further secure the connector 10 or parts of the connector 10, e.g.., the exhaust extension 14, to the off-road vehicle 100. Other fasteners 35, e.g., hose clamps 41, may also be used to secure the open end 24 of the chamber 22 to the exhaust end 102 of a silencer 104 or as a means of further securing together the ends of the exhaust passage 17 and exhaust extension 14 with the U-joint 16.

Referring now to FIGS. 2 and 7, the U-joint 16 is secured at one end 42 (a first end) by a connector 43 to the end 44 of the exhaust passage 17 that is opposite the discharge opening 30. Adhesives or the like may also be used with the connector 43 to assist in securing the U-joint 16 to the exhaust passage 17.

Referring to FIGS. 1-5, the extension 14 includes an end 54 that is secured to the other end 50 (a second end) of the U-joint by the use of a connector 43. Adhesives or the like may also be used with the connectors 42 to assist in securing the U-joint to the extension 14. When secured to the U-joint 16, the extension 14 preferably extends parallel to (and may even abut or be molded to) the exhaust passage 17. An exhaust opening 56 is provided in the extension 14 opposite the end 54 to permit sound and exhaust to be communicated into the atmosphere.

As discussed above, the component 10 is constructed of a heat-resistant and sound-deadening material. The adaptor 12 divides the exhaust and sound emitted from the silencer 104 in two. One portion of the exhaust and sound exits into the atmosphere through the exhaust port 26 and, in the process, is silenced to some degree by the sound-deadening material of the adapter 12 and the reduced area of the port 26. The other portion of the exhaust and sound is communicated through the passage 17, the U-joint 16 and the extension 14 wherein the sound is subjected to the sound-reducing effects of the material of the component 10 until entering the atmosphere through the exhaust opening 56.

Accordingly, the exhaust and particularly the sound emitted from the silencer 104 follow paths of different length that results in the sound exiting into the atmosphere out of phase. This results in sound pulses that are each of a lesser decibel level than the single pulse decibel level exiting the silencer 104 and the overall result of a reduced decibel level.

Having thus described my invention, various improvements will become apparent to those having skill in the art that do not depart from the scope of the present disclosure.

I claim:

1. A sound-reducing component for use with a vehicle silencer on an off-road vehicle comprising:
an adapter including a wall and an exhaust passage, the wall defining an exhaust discharge chamber, the exhaust discharge chamber having an exhaust port and a discharge opening, the exhaust port being operable to communicate exhaust and sound to the atmosphere and the discharge opening being operable to communicate exhaust and sound into the exhaust passage;
a U-joint having a first and a second end, the first end of the U-joint being secured to the exhaust passage; and
an exhaust extension having an exhaust opening and an end opposite the exhaust opening, the end of the exhaust extension being secured to the second end of the U-joint.

2. The sound-reducing component of claim 1, wherein the exhaust discharge chamber includes an open end.

3. The sound-reducing component of claim 2, wherein the area of the exhaust port is smaller than the area of the open end of the exhaust discharge chamber.

4. The sound-reducing component of claim 1, wherein the exhaust discharge chamber has an axis and the exhaust port is oriented at an angle relative to the axis of the exhaust discharge chamber.

5. The sound-reducing component of claim 5, wherein the exhaust port is oriented at an angle between 0 and 90 degrees relative to the axis of the exhaust discharge chamber.

6. The sound-reducing component of claim 1, further comprising a connector for securing the first end of the U-joint to the exhaust passage.

7. The sound-reducing component of claim 1, further comprising a connector for securing the second end of the U-joint to the end of the exhaust extension.

8. The sound-reducing component of claim 1, further comprising a sound deadening material.

9. The sound-reducing component of claim 1, further comprising a heat-resistant material.

10. A sound-reducing component for use with a vehicle silencer on an off-road vehicle comprising:
an off-road vehicle;
a silencer having an exhaust end and being mounted on the off-road vehicle;
an adapter that is positionable on the exhaust end of the silencer, the adapter including a wall and an exhaust passage, the wall defining an exhaust discharge chamber, the exhaust discharge chamber having an exhaust port and a discharge opening, the exhaust port being operable to communicate exhaust and sound to the atmosphere and the discharge opening being operable to communicate exhaust and sound into the exhaust passage;
a U-joint having first and second end, the first end of the U-joint being secured to the exhaust passage; and
an exhaust extension having an exhaust opening and an end opposite the exhaust opening, the end of the exhaust extension being secured to the second end of the U-joint.

11. The sound-reducing component of claim 10, further comprising a sound deadening material.

12. The sound-reducing component of claim 11, further comprising a heat-resistant material.

13. The sound-reducing component of claim 10, wherein the exhaust passage of the adapter extends substantially parallel to the silencer.

14. The sound-reducing component of claim 13, wherein the exhaust extension extends substantially parallel to the exhaust passage.

15. The sound-reducing component of claim 10, wherein the exhaust discharge chamber includes an open end, the open end being positionable over the exhaust end of the silencer.

16. The sound-reducing component of claim 15 wherein the area of the exhaust port is smaller than the area of the open end of the exhaust discharge chamber.

17. The sound-reducing component of claim 10, wherein the exhaust discharge chamber has an axis and the exhaust port is oriented at an angle relative to the axis of the exhaust discharge chamber.

18. The sound-reducing component of claim 17, wherein the exhaust port is oriented at an angle between 0 and 90 degrees relative to the axis of the exhaust discharge chamber.

19. The sound-reducing component of claim 10, further comprising a connector for securing the first end of the U-joint to the exhaust passage.

20. The sound-reducing component of claim 10, further comprising a connector for securing the second end of the U-joint to the end of the exhaust extension.

21. A sound-reducing component for use with a vehicle silencer on an off-road vehicle comprising:
an off-road vehicle;
a silencer having an exhaust end and being mounted on the off-road vehicle;
an adapter including a wall and an exhaust passage, the exhaust passage having an end, the wall having an inner surface that defines an exhaust discharge chamber, the exhaust discharge chamber having an open end, an exhaust port and a discharge opening, the open end being positionable around the exhaust end of the silencer, the exhaust port being operable to communicate exhaust and sound to the atmosphere and the discharge opening being operable to communicate exhaust and sound into the exhaust passage; and
an exhaust extension having an exhaust opening and an end opposite the exhaust opening, the end opposite the exhaust opening being in communication with the exhaust passage.

22. The sound-reducing component of claim 21 further comprising
a U-joint having first and second end; and
a first and a second connector, the first connector securing the first end of the U-joint to the end exhaust passage, the second connector securing the end of the exhaust extension to the second end of the U-joint

22. The sound-reducing component of claim 21 further comprising a fastener positioned on the exhaust passage of the adapter, the fastener being operable to secure the adapter to the off-road vehicle.

23. The sound-reducing component of claim 21 wherein the area of the exhaust port is smaller than the area of the open end of the exhaust discharge chamber.

24. The sound-reducing component of claim 23, wherein the exhaust discharge chamber has an axis and the exhaust port is oriented at an angle between 0 and 90 degrees relative to the axis of the exhaust discharge chamber.

25. The sound-reducing component of claim 24, wherein the exhaust passage of the adapter extends substantially parallel to the silencer and the exhaust extension extends substantially parallel to the exhaust passage.

26. The sound-reducing component of claim 21, further comprising a sound deadening material.

27. The sound-reducing component of claim 21, further comprising a heat-resistant material.
